(19) United States
(12) Patent Application Publication
(10) Pub. No.: US 2016/0204481 A1
(43) Pub. Date: Jul. 14, 2016

(54) SECONDARY BATTERY

(71) Applicant: SAMSUNG SDI CO., LTD., Yongin-si (KR)

(72) Inventor: Jaelim RYU, Yongin-si (KR)

(21) Appl. No.: 14/713,218

(22) Filed: May 15, 2015

(30) Foreign Application Priority Data
Jan. 8, 2015 (KR) 10-2015-0002851

(51) Int. Cl. H01M 10/48; H01M 10/42; H02J 7/00

(52) U.S. Cl. CPC H01M 10/486; H02J 7/0029; H01M 10/425; H01M 2010/4271

(57) ABSTRACT

A secondary battery includes at least one battery cell, a temperature sensor that detects information regarding a temperature of the battery cell, a protective circuit that receives temperature information output from the temperature sensor, and a sensor holder that accommodates the temperature sensor, the sensor holder including a first part formed at a side of the sensor holder and fixed to the protective circuit and a second part formed at another side of the sensor holder and pushed against the battery cell.

### CROSS-REFERENCE TO RELATED APPLICATION

Korean Patent Application No. 10-2015-0002851, filed on Jan. 8, 2015, in the Korean Intellectual Property Office, and entitled: “Secondary Battery,” is incorporated by reference herein in its entirety.

### BACKGROUND

1. Field

One or more exemplary embodiments relate to a secondary battery.

2. Description of the Related Art

Unlike primary batteries, secondary batteries are rechargeable. Secondary batteries are used as energy sources of devices such as mobile devices, electric vehicles, hybrid electric vehicles, electric bicycles, and uninterruptible power supplies. Single-cell secondary batteries or multi-cell secondary batteries (secondary battery packs or modules), in which a plurality of cells are connected, are used according to the types of external devices using the secondary batteries.

Small mobile devices such as cellular phones may be operated for a predetermined time using single-cell secondary batteries. However, multi-cell second batteries having high-output, high-capacity features may be suitable for devices having long operating times and consuming a large amount of power such as electric vehicles and hybrid electric vehicles.

### SUMMARY

Embodiments are directed to a secondary battery including at least one battery cell, a temperature sensor that detects information regarding a temperature of the battery cell, a protective circuit that receives temperature information output from the temperature sensor, and a sensor holder that accommodates the temperature sensor, the sensor holder including a first part formed at a side of the sensor holder and fixed to the protective circuit and a second part formed at another side of the sensor holder and pushed against the battery cell.

The sensor holder may include a sensor pocket accommodating the temperature sensor, a leg protruding from the sensor pocket toward the protective circuit, and a coupling part on the leg, the coupling part being coupled to the protective circuit.

The coupling part may hook to a coupling hole of the protective circuit.

The coupling part may include a slope inclined with respect to an assembling direction of the protective circuit and first and second jaws facing upper and lower surfaces of the protective circuit.

The sensor pocket may include a tetragonal cross section having four sides. The leg may include four legs respectively protruding from the four sides of the sensor pocket.

The temperature sensor may include a sensor chip that converts the information regarding the temperature of the battery cell into an electrical temperature signal and a lead wire that transmits the temperature signal of the sensor chip to the protective circuit.

The sensor chip may be located in the second part of the sensor holder. The lead wire may extend through the first part of the sensor holder and may be connected to the protective circuit.

An end portion of the first part of the sensor holder may be open such that the lead wire passes therethrough.

The lead wire may be a rigid metal wire. A connection hole may be located in the protective circuit to receive an end portion of the lead wire.

A connection pattern extending from the connection hole may be located on the protective circuit.

The lead wire of the temperature sensor may be in an inserted position in the connection hole of the protective circuit and may be electrically connected with the protective circuit.

The lead wire may be insertable through the connection hole.

The first and second parts of the sensor holder may be formed of different materials.

The second part of the sensor holder may be formed of a metallic material.

A shock-absorbing pad may be located between the sensor holder and the battery cell.

### BRIEF DESCRIPTION OF THE DRAWINGS

Features will become apparent to those of skill in the art by describing in detail exemplary embodiments with reference to the attached drawings in which:

FIG. 1 illustrates an exploded perspective view depicting a secondary battery according to an exemplary embodiment;

FIG. 2 illustrates an enlarged view of a portion of FIG. 1;

FIG. 3 illustrates a perspective view depicting a temperature sensor illustrated in FIG. 2; and

FIG. 4 illustrates a cut-away view depicting an installation of the temperature sensor.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. Like reference numerals refer to like elements throughout.

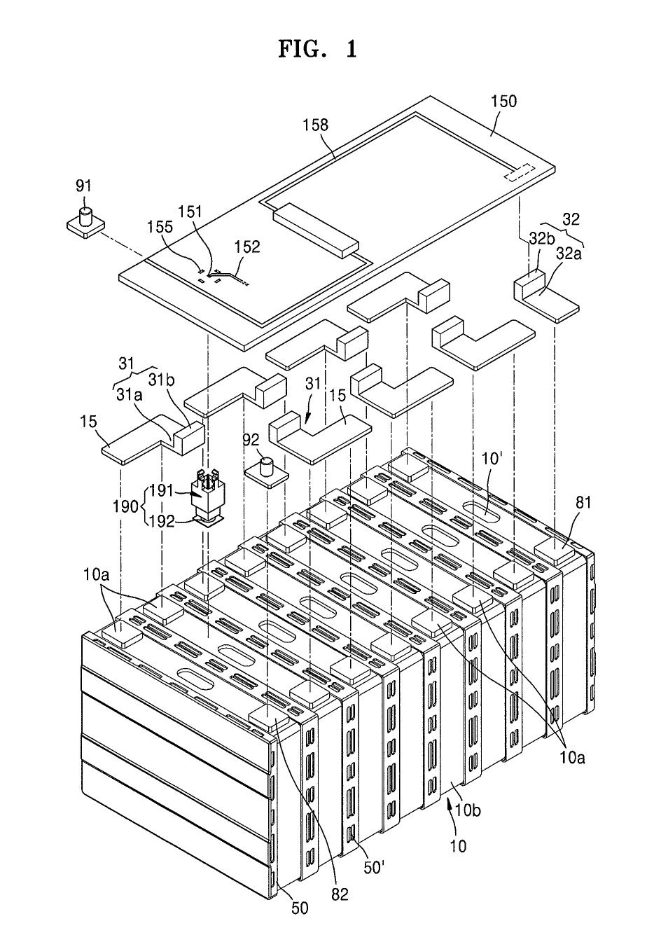

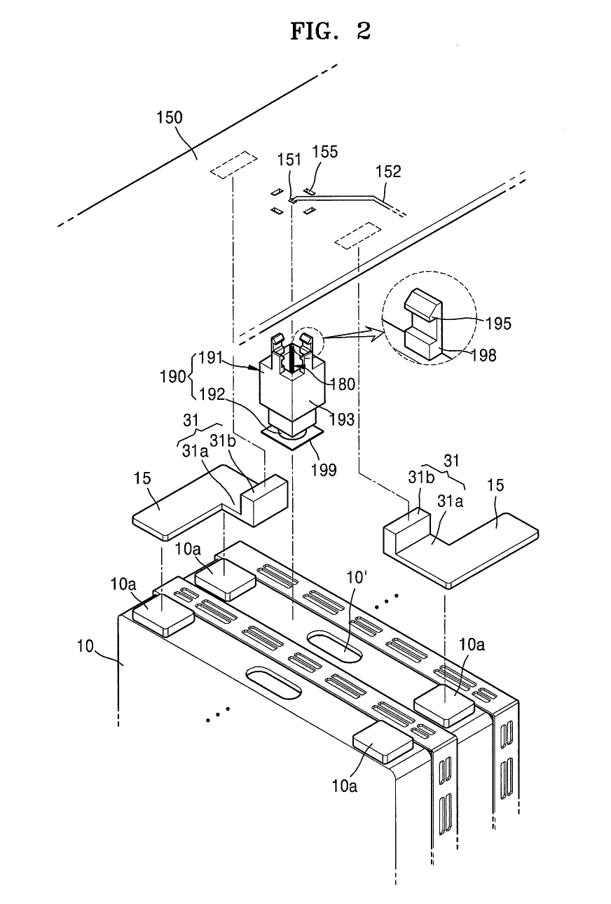

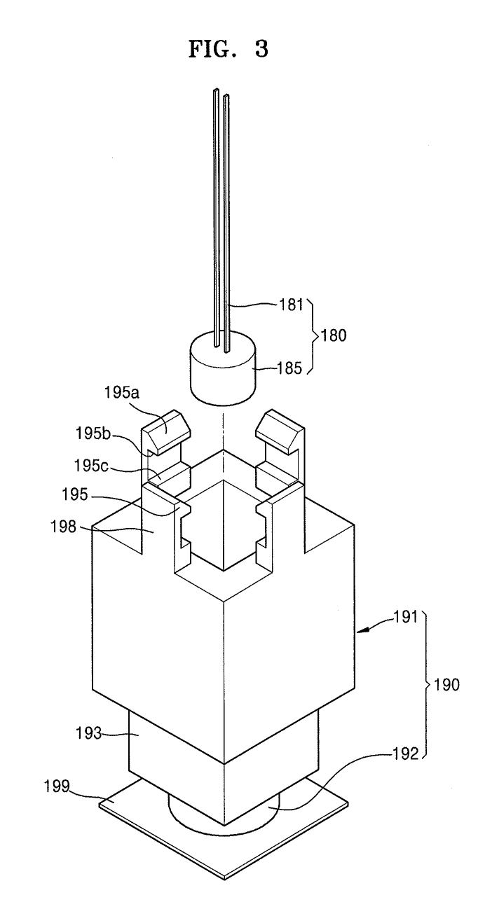

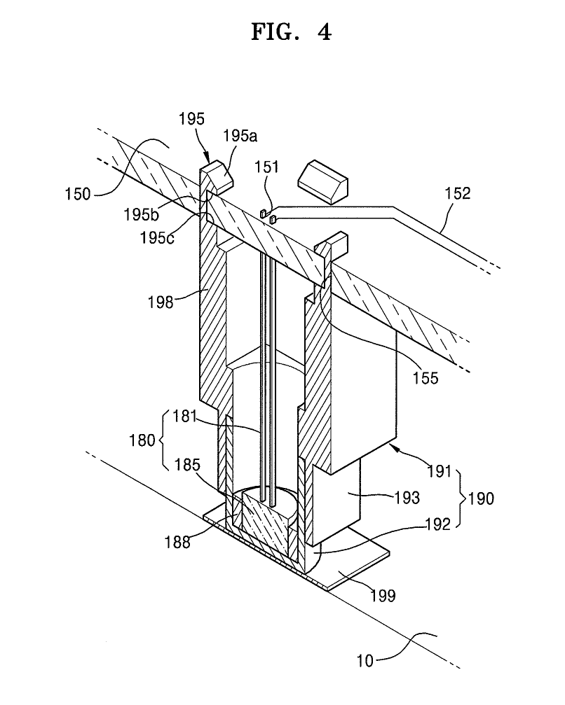

FIG. 1 illustrates an exploded perspective view depicting a secondary battery according to an exemplary embodiment. FIG. 2 illustrates an enlarged view of a portion of FIG. 1. FIG. 3 illustrates a perspective view depicting a temperature sensor 180 illustrated in FIG. 2. FIG. 4 illustrates a cut-away view depicting an installation of the temperature sensor 180 according to a method of installing the temperature sensor 180.

Referring to FIG. 1, the secondary battery may include a plurality of battery cells 10 arranged in a row in one direction; and a protective circuit (circuit board) 150 electrically connected to the battery cells 10. In addition, the secondary battery may include wiring parts 31 and 32 disposed on the battery cells 10 for electrically connecting the protective circuit (circuit board) 150 and the battery cells 10 together.

The battery cells 10 may be secondary battery cells such as lithium ion battery cells. The battery cells 10 may have a suitable shape such as a cylindrical shape or a prismatic shape. In addition, the battery cells 10 may be a suitable type of battery cell such as a polymer battery cell.

For example, each of the battery cells 10 may include a case 10b, an electrode assembly disposed in the case 10b, and electrode terminals 10a electrically connected to the electrode assembly and exposed to the outside of the case 10b. For example, the electrode terminals 10a may be exposed to the outside of the case 10b and may form portions of an upper side of the case 10b. The electrode assembly may include a positive electrode plate, a separator, and a negative electrode plate. The electrode assembly may be a jelly-roll or stacked type electrode assembly. The case 10b may accommodate the electrode assembly, and the electrode terminals 10a may be exposed to the outside of the case 10b for electrically connecting the electrode assembly to the protective circuit (circuit board) 150.

For example, neighboring battery cells 10 may be electrically connected to each other by connecting electrode terminals 10a of the neighboring battery cells 10. For example, neighboring battery cells 10 may be electrically connected in series or parallel to each other by connecting electrode terminals 10a of the neighboring battery cells 10 using bus bars 15.

A safety vent 10′ may be formed in the case 10b. The safety vent 10′ may be relatively weak such that if internal pressure of the case 10b becomes equal to or higher than a preset critical value, the safety vent 10′ may be fractured to release gas from the inside of the case 10b.

Spacers 50 may be disposed between neighboring battery cells 10. The spacers 50 may insulate the neighboring battery cells 10 from each other. For example, the cases 10b of the battery cells 10 may have electrical polarities, and the spacers 50 may be formed of an insulation material and disposed between the cases 10b to prevent electrical interference between the battery cells 10. In addition, the spacers 50 may form gaps between the battery cells 10 as heat-dissipating paths. To this end, heat-dissipating holes 50′ may be formed in the spacers 50.

The spacers 50 may be disposed between the battery cells 10 and may prevent thermal expansion (swelling) of the battery cells 10. The cases 10b of the battery cells 10 may be formed of a deformable material such as metal. The spacers 50 may be formed of a less deformable material than that of the cases 10b such as polymers so as to suppress swelling of the battery cells 10.

The wiring parts 31 and 32 may include detection wiring parts 31 that detect state information such as voltages and temperatures of the battery cells 10, and a connection wiring part 32 that allows a charging/discharging current to flow therethrough. Information regarding states of the battery cells 10, obtained using the wiring parts 31 and 32, may be provided to the protective circuit (circuit board) 150 and may be used as data for determining abnormal states of the battery cells 10 such as overheating, overcharging, or overdischarging, or for checking operational states of the battery cells 10 such as charging and discharging states.

The detection wiring parts 31 may extend from the electrode terminals 10a of the battery cells 10 or the bus bars 15 connected to the electrode terminals 10a for obtaining voltage detection signals from the battery cells 10. In the exemplary embodiment shown in FIG. 1, the detection wiring parts 31 may be protrusions protruding from the bus bars 15 toward the protective circuit (circuit board) 150. For example, the detection wiring parts 31 may include protrusions including extensions 31a continuously extending from the bus bars 15 and terminal portions 31b connected to connection patterns of the protective circuit (circuit board) 150. For example, the detection wiring parts 31 may include extensions 31 a extending from the bus bars 15, and terminal portions 31b protruding upward from the extensions 31a toward the protective circuit (circuit board) 150. The terminal portions 31b may be connected to the connection patterns (denoted by dashed lines in FIG. 2) of the protective circuit (circuit board) 150.

In another exemplary embodiment, the detection wiring parts 31 may be flexible wires that include connectors provided on ends thereof for connection to the bus bars 15 and the other connectors provided on the other ends thereof to connect to the protective circuit (circuit board) 150.

The detection wiring parts 31 may measure voltages at a plurality of positions having different electrical potentials. For example, a detection wiring part 31 may be allocated to a pair of neighboring battery cells 10. Each pair of neighboring battery cells 10 may be electrically connected through one bus bar 15.

The detection wiring parts 31 may be connected to the protective circuit (circuit board) 150. The protective circuit (circuit board) 150 may control charging and discharging operations of the battery cells 10 based on voltage detection signals obtained through the detection wiring parts 31.

Referring to FIG. 1, the wiring parts 31 and 32 may include the connection wiring part 32 so as to electrically connect a first output terminal 81 of one of the secondary batteries to the protective circuit (circuit board) 150 and thus form a charging/discharging current path. For example, the connection wiring part 32 may be a protrusion continuously extending from the first output terminal 81 or a second output terminal 82. For example, the connection wiring part 32 may include an extension 32a extending from the first output terminal 81, and a terminal portion 32b protruding upward from the extension 32a toward the protective circuit (circuit board) 150.

In another exemplary embodiment, the connection wiring part 32 may be a flexible wire including a ring terminal provided on an end thereof for connection to the first output terminal 81 and a connector provided on the other end thereof to connect to the protective circuit (circuit board) 150.

The connection wiring part 32 may form a large current line through which a large amount of charging/discharging current flows. The detection wiring parts 31 may form small current lines to transmit detection signals. For example, the connection wiring part 32 may have a wide sectional area to reduce the resistance thereof. The connection wiring part 32 may be disposed on one of the first and second output terminals 81 and 82 having different polarities.

The connection wiring part 32 may form the charging/discharging current path connected to the first output terminal 81. For example, the connection wiring part 32 may be connected to the protective circuit (circuit board) 150. A conductive pattern 158 (corresponding to the charging/discharging current path) may be formed on the protective circuit (circuit board) 150 to allow a charging/discharging current to flow through.

For example, the charging/discharging current path may be defined from the first output terminal 81 to a first external terminal 91 through the connection wiring part 32 connected to the first output terminal 81 and the conductive pattern 158 of the protective circuit (circuit board) 150. The second output terminal 82 may be connected to a second external terminal 92 through a connection wire or circuit devices.

The first and second output terminals 81 and 82 may constitute an electrode terminal 10a of a first battery cell 10 and an electrode terminal 10a of a second battery cell 10. The first and second output terminals 81 and 82 may be electrically connected to the first and second external terminals 91 and 92 disposed outside a case (not shown). A load may be connected between the first and second external terminals 91 and 92.

The protective circuit (circuit board) 150 may monitor charging and discharging states of the battery cells 10 such as the amounts of remaining charge (charged amounts) or overcharging/overdischarging states, based on voltage detection signals obtained through the detection wiring parts 31 and temperature detection signals measured using the temperature sensor 180. The protective circuit (circuit board) 150 may control the charging and discharging operations of the battery cells 10 based on the monitoring.

Referring to FIGS. 2 and 3, the temperature sensor 180 may be disposed on the battery cells 10 to generate temperature detection signals. For example, the temperature sensor 180 may be disposed between the battery cells 10 and the protective circuit (circuit board) 150. The protective circuit (circuit board) 150 may push the temperature sensor 180 against the battery cells 10. For example, a plurality of temperature sensors 180 may be disposed with respect to pairs of neighboring battery cells 10, respectively. Many temperature sensors 180 may be desirable to individually measure the temperatures of the battery cells 10. A single temperature sensor 180 may be disposed with respect to a pair of neighboring battery cells 10 at a position between the neighboring battery cells 10 and the protective circuit (circuit board) 150.

Temperature detection signals generated by the temperature sensor 180 may be transmitted to the protective circuit (circuit board) 150. For example, the temperature sensor 180 may be connected to a circuit board forming the protective circuit (circuit board) 150. For example, in a state in which the temperature sensor 180 is connected to a connection pattern 152 of the protective circuit (circuit board) 150, the temperature sensor 180 may be disposed on the battery cells 10 together with the protective circuit (circuit board) 150.

For example, the position of the temperature sensor 180 may be fixed relative to the protective circuit (circuit board) 150 in a state in which the temperature sensor 180 is disposed in a sensor holder 190. The sensor holder 190 accommodating the temperature sensor 180 may include a first part 191 fixed to the protective circuit (circuit board) 150 and a second part 192 pushed against the battery cells 10.

The first and second parts 191 and 192 may be upper and lower parts of the sensor holder 190. The first part 191 may be relatively close to the protective circuit (circuit board) 150, and the second part 192 may be relatively close to the battery cells 10.

For example, the first part 191 may be an upper part of the sensor holder 190 including an upper part of a sensor pocket 193 accommodating the temperature sensor 180, legs 198 protruding from the sensor pocket 193, and coupling parts 195. The second part 192 may be a lower part of the sensor holder 190 including a lower part of the sensor pocket 193 accommodating the temperature sensor 180. As described below, the first and second parts 191 and 192 of the sensor holder 190 may be formed of different materials. For example, the second part 192 disposed close to the battery cells 10 may be formed of a metallic material having high thermal conductivity. This will be described below in more detail.

Referring to FIG. 3, the temperature sensor 180 may include a sensor chip 185 and lead wires 181 that receive power from outside and transmit electrical temperature signals generated by the sensor chip 185. For example, the temperature sensor 180 may receive power through an outer device such as the protective circuit (circuit board) 150 and may transmit electrical detection signals to the protective circuit (circuit board) 150.

For example, the sensor chip 185 may include a variable resistor having resistance varying according to the temperature of a detection target object such as the battery cells 10. The sensor chip 185 may include a packing material on a surface thereof to protect internal parts of the sensor chip 185. For example, the internal parts of the sensor chip 185 may be embedded in the packing material, and thus, the internal parts of the sensor chip 185 may be protected from impact or foreign substances.

The sensor chip 185 may be accommodated in the second part 192 of the sensor holder 190. The second part 192 of the sensor holder 190 may be formed of a thermally conductive material such as a metal and may form a heat transfer path between the sensor chip 185 and the battery cells 10.

Electrical temperature signals generated by the sensor chip 185 may be transmitted to the protective circuit (circuit board) 150 through the lead wires 181. For example, the lead wires 181 may extend from the sensor chip 185 to the protective circuit (circuit board) 150 through the first part 191 of the sensor holder 190. In this case, an upper end of the first part 191 may be open to allow the lead wires 181 to extend outward. The lead wires 181 may extend outward and may be connected to the protective circuit (circuit board) 150.

Referring to FIGS. 2 and 4, end portions of the lead wires 181 may be inserted in connection holes 151 of the protective circuit (circuit board) 150. The lead wires 181 may penetrate through the protective circuit (circuit board) 150. The connection pattern 152 may be formed on the protective circuit (circuit board) 150 such that the connection pattern 152 may extend from the connection holes 151. The lead wires 181 connected to the connection pattern 152 may transmit electrical temperature signals to the protective circuit (circuit board) 150. The protective circuit (circuit board) 150 may control charging and discharging operations of the battery cells 10 based on the temperature signals.

The connection holes 151 may be formed in an inner region surrounded by coupling holes 155. For example, a plurality of coupling holes 155 may be formed. A pair of the connection holes 151 may be formed in a region surrounded by the coupling holes 155. The pair of connection holes 151 may correspond to the two lead wires 181. Power may be supplied to the temperature sensor 180 through one of the lead wires 181, and electrical temperature signals may be transmitted from the temperature sensor 180 through the other lead wire 181.

The lead wires 181 may be rigid wires including fine metal wires. For example, in a state in which the lead wires 181 extend upward from the sensor chip 185 toward the protective circuit (circuit board) 150, the lead wires 181 may be straight without bending by the weights thereof.

The temperature sensor 180 and the protective circuit (circuit board) 150 may be electrically connected to each other through the lead wires 181 when the sensor holder 190 and the protective circuit (circuit board) 150 are mechanically coupled. For example, when the coupling parts 195 of the sensor holder 190 are inserted into the coupling holes 155 of the protective circuit (circuit board) 150, respectively, the lead wires 181 may be inserted into the connection holes 151 of the protective circuit (circuit board) 150. In an assembling position of the sensor holder 190, the lead wires 181 may be inserted in the connection holes 151 of the protective circuit (circuit board) 150 to electrically connect with the protective circuit (circuit board) 150. At this time, the sensor holder 190 may fix the position of the temperature sensor 180 relative to a lower side of the protective circuit (circuit board) 150. At the same time, the lead wires 181 of the temperature sensor 180 may be electrically connected to the connection pattern 152 adjoining the connection holes 151.

According to the exemplary embodiment, the position fixation and electric connection of the temperature sensor 180 may be simultaneously accomplished through a single action of pushing the sensor holder 190 accommodating the temperature sensor 180 against the protective circuit (circuit board) 150 to insert the coupling parts 195 of the sensor holder 190 and the lead wires 181 of the temperature sensor 180 into the coupling holes 155 and the connection holes 151 of the protective circuit (circuit board) 150. Accordingly a situation may be avoided where the position fixation and electric connection of a temperature sensor must be individually accomplished through at least two actions and where a temperature sensor and a protective circuit are connected through flexible wires that are not easy to handle, or where ends of the flexible wires must be connected to the protective circuit (circuit board) using an additional connector.

According to the exemplary embodiment, the position fixation and electric connection of the temperature sensor 180 may be accomplished in one action by simply pushing the sensor holder 190 accommodating the temperature sensor 180 against the protective circuit (circuit board) 150. For example, the sensor holder 190 accommodating the temperature sensor 180 may be disposed between the protective circuit (circuit board) 150 and the battery cells 10, and then the protective circuit (circuit board) 150 may be pushed against the battery cells 10 to bring the temperature sensor 180 into tight contact with surfaces of the battery cells 10 and thus improve the accuracy of measuring temperature. In this manner, the present states of the battery cells 10 may be accurately detected, and charging and discharging operations of the battery cells 10 may be accurately controlled.

Referring to FIG. 4, when the lead wires 181 are fully inserted through the connection holes 151 of the protective circuit (circuit board) 150, the lead wires 181 may completely penetrate the protective circuit (circuit board) 150, which may ensure the connection of the lead wires 181 when the sensor holder 190 is at the assembling position thereof even through there may be machining tolerances. For example, the lead wires 181 may be coupled to the protective circuit (circuit board) 150 to penetrate through the protective circuit (circuit board) 150 and sufficiently protrude upward from the protective circuit (circuit board) 150 so as to provide the connection of the lead wires 181. Therefore, although the assembling position of the sensor holder 190 may somewhat vary due to machining tolerance, the connection of the lead wires 181 may be surely provided.

End portions of the lead wires 181 may be securely connected to the protective circuit (circuit board) 150 by a thermal joining method such as soldering. For example, the lead wires 181 may be primarily connected to the protective circuit (circuit board) 150 at the assembling position of the sensor holder 190, and then the lead wires 181 may be finally connected to the protective circuit (circuit board) 150 by soldering the end portions of the lead wires 181 exposed at the protective circuit (circuit board) 150 to the connection pattern 152 adjoining the connection holes 151.

Referring to FIG. 4, the temperature sensor 180 may be accommodated in the sensor holder 190 and fixed relative to the protective circuit (circuit board) 150 by the sensor holder 190. The sensor holder 190 may include the sensor pocket 193 accommodating the temperature sensor 180, the legs 198 protruding from the sensor pocket 193 toward the protective circuit (circuit board) 150, and the coupling parts 195 formed on the legs 198 that couple with the protective circuit (circuit board) 150.

The sensor holder 190 may be fixed to the protective circuit (circuit board) 150 by using the coupling parts 195. For example, the coupling parts 195 may be in the form of hooks coupled to the coupling holes 155 of the protective circuit (circuit board) 150. For example, the coupling parts 195 may include slopes 195a that are inclined with respect to an assembling direction in which the coupling parts 195 are coupled to the protective circuit (circuit board) 150 and first and second jaws 195b and 195c facing upper and lower surfaces of the protective circuit (circuit board) 150.

The slopes 195a may reduce resistance when the sensor holder 190 is assembled to the protective circuit (circuit board) 150. The first and second jaws 195b and 195c may prevent the sensor holder 190 from separating from the protective circuit (circuit board) 150 in a direction opposite the assembling direction. The first and second jaws 195b and 195c preventing the sensor holder 190 from moving away from the assembling position may be formed to face each other and may contact the upper and lower surfaces of the protective circuit (circuit board) 150.

A gap between the first and second jaws 195b and 195c may correspond to the thickness of the protective circuit (circuit board) 150. The position of the sensor holder 190 may be fixed with respect to the protective circuit (circuit board) 150 by the first and second jaws 195b and 195c making contact with the upper and lower surfaces of the protective circuit (circuit board) 150. With the first and second jaws 195b and 195c facing each other with a gap substantially having the same length as the thickness of the protective circuit (circuit board) 150, the sensor holder 190 may be stably maintained at the fixed position.

The first and second jaws 195b and 195c may be provided as a pair for each of the legs 198 protruding upward from the sensor pocket 193. For example, if the sensor pocket 193 has an approximately tetragonal cross section, the legs 198 may respectively protrude from four sides of the sensor pocket 193, and the first and second jaws 195b and 195c may be formed on each of the legs 198 as a pair facing each other with a gap therebetween.

Referring to FIG. 4, the coupling parts 195 may be formed at a plurality of positions to firmly fix the sensor holder 190. For example, if the sensor pocket 193 has a tetragonal cross section having four sides, four legs 198 may protrude from the four sides of the sensor pocket 193, respectively. In addition, four coupling parts 195 may be formed on the legs 198, respectively. The coupling parts 195 may be formed at symmetric positions of the sensor pocket 193 to firmly fix the sensor holder 190.

The sensor holder 190 may include the sensor pocket 193 to accommodate the temperature sensor 180 An upper end portion of the sensor pocket 193 may be open to receive the temperature sensor 180. The lead wires 181 of the temperature sensor 180 may extend outwardly through the open upper end portion of the sensor holder 190.

Referring to FIG. 4, the temperature sensor 180 may be accommodated in the sensor holder 190. It will now be described how the temperature sensor 180 is disposed. The sensor chip 185 of the temperature sensor 180 may be disposed in the second part 192 of the sensor holder 190, which is close to the battery cells 10. The sensor chip 185 generates electrical temperature signals. Accordingly, the sensor chip 185 may be disposed as close as possible to the battery cells 10. In addition, the lead wires 181 extending from the sensor chip 185 may be connected to the protective circuit (circuit board) 150 through the first part 191 of the sensor holder 190. An adhesive 188 may be filled in a gap formed between the sensor chip 185 and the sensor holder 190 (specifically, the second part 192 of the sensor holder 190) along the circumference of the sensor chip 185 so as to prevent movement of the sensor chip 185 relative to the sensor holder 190.

The sensor holder 190 may include the first and second parts 191 and 192 formed of different materials. For example, the first part 191 of the sensor holder 190 may be an upper part of the sensor holder 190 that is relatively close to the protective circuit (circuit board) 150. The second part 192 the sensor holder 190 may be a lower part of the sensor holder 190 that is relatively close to the battery cells 10. The first part 191 disposed close to the protective circuit (circuit board) 150 and coupled to the protective circuit (circuit board) 150, on which electric devices and a circuit pattern are formed, may be formed of an electrically insulative material. In this case, electric operations of the protective circuit (circuit board) 150 may be performed without interference. For example, the first part 191 of the sensor holder 190 may be formed of polymer resin.

The second part 192 of the sensor holder 190, disposed close to the battery cells 10 from which temperatures will be measured, may transfer heat generated during operations of the battery cells 10 without loss. To this end, the second part 192 of the sensor holder 190 may be formed of a metallic material having a low degree of thermal resistance. In this case, when the second part 192 transfers operational heat of the battery cells 10 to the temperature sensor 180, thermal loss may be minimized. For example, the second part 192 of the sensor holder 190 may be formed of aluminum.

A shock-absorbing pad 199 may be disposed between the sensor holder 190 and the battery cells 10. The shock-absorbing pad 199 may absorb impact between the sensor holder 190 and the battery cells 10 and may help to maintain tight contact between the sensor holder 190 and the battery cells 10.

For example, the second part 192 of the sensor holder 190 may be formed of a metallic material, and the case 10b of the battery cells 10 facing the second part 192 may be formed of a metallic material. If the metallic materials, which are relatively hard, are in contact with each other, if an impact or vibration were to occur on the second part 192 and the battery cells 10, a gap could be formed between the second part 192 and the battery cells 10, and the second part 192 and the battery cells 10 could impact each other without shock absorption. However, according to an embodiment, the shock-absorbing pad 199 may be disposed between the second part 192 of the sensor holder 190 and the battery cells 10. Therefore, impact between the second part 192 and the battery cells 10 may be absorbed, and the second part 192 and the battery cells 10 may not be damaged by a relative movement between the second part 192 and the battery cells 10.

The battery cells 10 and the second part 192 that are formed of relatively hard metallic materials may be brought into tight contact with each other through the shock-absorbing pad 199. For example, the shock-absorbing pad 199 may be disposed between the second part 192 and the battery cells 10, that is, between two metal surfaces that are difficult to form a tight contact with each other due to reasons such as machining tolerance. Therefore, the second part 192 and the battery cells 10 may form a tight contact with each other through the shock-absorbing pad 199.

The shock-absorbing pad 199 disposed between the second part 192 and the battery cells 10 may reduce the influence of machining tolerances of the second part 192 and the battery cells 10. For example, although it is desirable that the second part 192 and the battery cells 10 be as close as possible, due to machining tolerance, it may be designed that a gap is formed between the second part 192 and the battery cells 10. In this case, the shock-absorbing pad 199 disposed between the second part 192 and the battery cells 10 may reduce the influence of machining tolerances of the second part 192 and the battery cells 10.

The shock-absorbing pad 199 disposed between the second part 192 and the battery cells 10 may be formed of a shock-absorbing material. In addition, the shock-absorbing pad 199 may be formed of a material having a high degree of thermal conductivity so as to provide an effective thermal path between the second part 192 and the battery cells 10. Operational heat dissipated from surfaces of the battery cells 10 may be transferred to the second part 192 through the shock-absorbing pad 199 and may be converted into an electric signal by the temperature sensor 180.

The shock-absorbing pad 199 may be formed of a material having a shock-absorbing ability and thermal conductivity. For example, the shock-absorbing pad 199 may be formed by a thermally conductive material through a foaming process. For example, the shock-absorbing pad 199 may have a thickness of about 0.2 mm to about 1 mm.

By way of summation and review, in a multi-cell second battery, in which a plurality of battery cells are closely arranged, if a battery cell deteriorates, neighboring battery cells may sequentially deteriorate or the safety of the battery cells may be markedly lowered because of, for example, thermal runaway, and thus, the possibility of negligent accidents may be increased.

Therefore, the temperatures of secondary batteries are monitored to detect abnormal states such as overheating and to prevent accidents such as ignition and explosions. To this end, secondary batteries may be equipped with a temperature sensor and a circuit for processing signals output from the temperature sensor. However, in a general multi-cell secondary battery, positioning and fixation of a temperature sensor may involve complicated actions. A temperature sensor and a circuit may be connected through flexible wires that are not easily handled, and/or an additional connector may be required.

As described above, according to the one or more of the above exemplary embodiments, since the position fixation and electric connection of the temperature sensor 180 are simultaneously accomplished through a single action, the assembling of the secondary battery may be easily performed.

Furthermore, in the secondary battery, the temperature sensor 180 is brought into tight contact with battery cells 10, and thus, the temperature of the battery cells 10 may be accurately measured.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope thereof t as set forth in the following claims.

What is claimed is:

1. A secondary battery, comprising:
at least one battery cell;
a temperature sensor that detects information regarding a temperature of the battery cell;
a protective circuit that receives temperature information output from the temperature sensor; and
a sensor holder that accommodates the temperature sensor, the sensor holder including a first part formed at a side of the sensor holder and fixed to the protective circuit and a second part formed at another side of the sensor holder and pushed against the battery cell.

2. The secondary battery as claimed in claim 1, wherein the sensor holder includes:
a sensor pocket accommodating the temperature sensor;
a leg protruding from the sensor pocket toward the protective circuit; and
a coupling part on the leg, the coupling part being coupled to the protective circuit.

3. The secondary battery as claimed in claim 2, wherein the coupling part hooks to a coupling hole of the protective circuit.

4. The secondary battery as claimed in claim 3, wherein the coupling part includes:
a slope inclined with respect to an assembling direction of the protective circuit; and
first and second jaws facing upper and lower surfaces of the protective circuit.

5. The secondary battery as claimed in claim 2, wherein:
the sensor pocket includes a tetragonal cross section having four sides, and
the leg includes four legs respectively protruding from the four sides of the sensor pocket.

6. The secondary battery as claimed in claim 1, wherein the temperature sensor includes:
a sensor chip that converts the information regarding the temperature of the battery cell into an electrical temperature signal; and
a lead wire that transmits the temperature signal of the sensor chip to the protective circuit.

7. The secondary battery as claimed in claim 6, wherein;
the sensor chip is located in the second part of the sensor holder, and
the lead wire extends through the first part of the sensor holder and is connected to the protective circuit.

8. The secondary battery as claimed in claim 7, wherein an end portion of the first part of the sensor holder is open such that the lead wire passes therethrough.

9. The secondary battery as claimed in claim 6, wherein:
the lead wire is a rigid metal wire, and
a connection hole is located in the protective circuit to receive an end portion of the lead wire.

10. The secondary battery as claimed in claim 9, wherein a connection pattern extending from the connection hole is located on the protective circuit.

11. The secondary battery as claimed in claim 9, wherein the lead wire of the temperature sensor is in an inserted position in the connection hole of the protective circuit and electrically connected with the protective circuit.

12. The secondary battery as claimed in claim 9, wherein the lead wire is insertable through the connection hole.

13. The secondary battery as claimed in claim 1, wherein the first and second parts of the sensor holder are formed of different materials.

14. The secondary battery as claimed in claim 13, wherein the second part of the sensor holder is formed of a metallic material.

15. The secondary battery as claimed in claim 1, wherein a shock-absorbing pad is located between the sensor holder and the battery cell.
